(19) United States
(12) Patent Application Publication
(10) Pub. No.: US 2025/0085944 A1
(43) Pub. Date: Mar. 13, 2025

(54) METHOD AND APPARATUS FOR GENERATING NATIVE APPLICATION FROM NON-NATIVE DEVELOPMENT ENVIRONMENT

(71) Applicant: 650 Industries, Inc., Palo Alto, CA (US)

(72) Inventors: Evan Joseph BACON, Austin, TX (US); James Hiroaki IDE, Palo Alto, CA (US)

(21) Appl. No.: 18/243,611

(22) Filed: Sep. 7, 2023

(51) Int. Cl. G06F 8/51

(52) U.S. Cl. CPC G06F 8/51

(57) ABSTRACT

Methods and systems for generating a native application include i. receiving a non-native configuration in a non-native development environment; and ii. generating, within the non-native development environment, an application configuration for a native development environment based on the non-native configuration file.

### BACKGROUND

### Field

Embodiments generally relate to generating application files, and particularly towards a method and apparatus for generating native application within a non-native development environment.

### Description of the Related Art

Recent application development trends, for example, in mobile application development, have trended towards developing multiple versions of an application for different native environments (e.g., iOS and ANDROID). A developer may separately write one version of an application for each development environment (e.g., one version for iOS and another version for ANDROID). In such an example, the developer writes separate applications within separate development environments. Thus, any time a developer needs to make a change to an application version, the developer must carefully track changes to multiple files in each native environment. Aside from requiring additional time and effort to effect changes, such a manual process can lead to inadvertent errors.

Therefore, there is a need in the art for an application development environment that can streamline and improve application development.

### SUMMARY

According to one embodiment, there is provided a method for generating an application configuration for a native development environment, the method comprising: i. receiving a non-native configuration in a non-native development environment; and ii. generating, within the non-native development environment, an application configuration for a native development environment based on the non-native configuration.

According to some embodiments, one or more non-transitory computer readable media having instructions stored thereon which, when executed by one or more processors, cause the one or more processors to perform operations for generating an application configuration for a native development environment, the operations comprising: i. receiving a non-native configuration in a non-native development environment; and ii. generating, within the non-native development environment, an application configuration for a native development environment based on the non-native configuration.

According to some embodiments, a system for generating an application configuration for a native development environment, the system comprising: one or more processors; and one or more non-transitory computer readable media storing instructions, which, when executed by one or more processors, cause the one or more processors to perform the operations comprising: i. receiving a non-native configuration in a non-native development environment; and ii. generating, within the non-native development environment, an application configuration for a native development environment based on the non-native configuration.

Other and further embodiments of the present disclosure are described below.

### BRIEF DESCRIPTION OF THE DRAWINGS

So that the manner in which the above recited features of the present embodiments can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a native application configuration generation tool in accordance with some embodiments of the present disclosure.

FIG. 2 illustrates a flow diagram for a method in accordance with some embodiments of the present disclosure.

FIG. 3 is a block diagram for a native application configuration generation tool in accordance with some embodiments of the present disclosure.

FIG. 4 is a block diagram for a native application configuration generation tool in accordance with some embodiments of the present disclosure.

FIG. 5 is a block diagram of a computer system in accordance with some embodiments of the present disclosure.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

During development of different native versions of an application, a developer may encounter many similarities for configuring the applications in the different native development environments. For example, the similarities may include the name of the application, the icon used on the home screen, capabilities for accessing hardware on a device, etc. Nevertheless, despite such similarities between features, a developer often must separately write programming code in each native language for such features when developing each native version of an application. More specifically, the native application configuration files for each native version of an application are different. For example, the way an Android project is represented is different from the way an iOS project is represented and the Android and iOS files are completely different. For instance, some of the configuration for building an Android application is often in build.gradle files, while some of the configuration for building an iOS application is in .xcodeproj/.xcworkspace files. Also, some of the configuration of an Android app is in a file called AndroidManifest.xml, while much of the configuration of an iOS app is in a file called INFO.PLIST. As discussed in greater detail herein, in some embodiments, continuous native generation modifies all of the above, i.e., the native project files, the application configuration files, and some of the application source code files (which may be written in Kotlin/Java and Objective-C/Swift).

Embodiments disclosed herein relate to a native application generation tool that generates native application configuration files within a non-native development environment to take advantage of the commonalities between various native development environments. In some embodiments, the tool can be used to generate native application configuration files on the fly from a common set of non-native configuration files. The native application configuration files can be regenerated at any time (i.e., “on-the-fly”) within the non-native development environment so that any changes made to the non-native configuration files will be reflected upon regeneration of the native application configuration files. Further, in some embodiments, the native application generation tool allows for configuration of non-native third-party libraries that allow the third-party libraries to be generated and integrated into native applications.

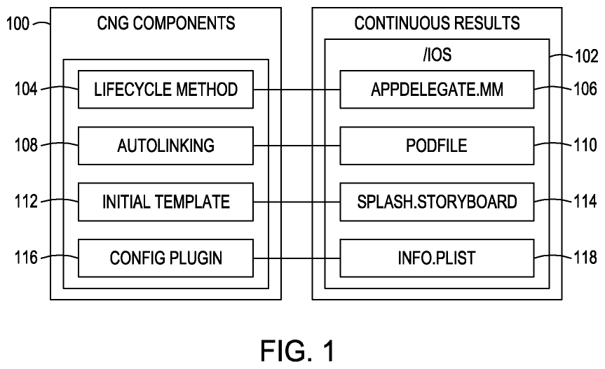

FIG. 1 shows a block diagram showing correspondence between components of native application configuration generation tool 100 and native (e.g., an iOS application) application configuration files within a directory 102 continuously generated and/or updated by the components. As used herein, “continuous” refers to the ability to update the native application configuration files automatically based on changes to a non-native configuration. Thus, any time a user makes a change to a non-native configuration, the native configuration files can be automatically regenerated without having to manually rewrite each native configuration file. As used herein, “non-native” refers to being related to a development environment other than a native development environment.

In some embodiments, and as shown in FIG. 1, a native application configuration generation tool 100 may be configured to generate and/or update native configuration files for a native (e.g., iOS) application. In the embodiment shown in FIG. 1, the native application configuration generation tool 100 may include a lifecycle method component 104 configured for generating and/or updating an AppDelegate.mm file 106, an autolinking component 108 configured for generating a PODFILE 110, an initial template component 112 configured for generating a SPLASH.STORYBOARD 114, and a config plugin component 116 configured for generating an INFO.PLIST 118. In some embodiments, the components of the native application configuration generation tool 100 may be configured to generate native configuration files for other or additional native development environments, including, but not limited to WINDOWS, macOS, LINUX, and ANDROID.

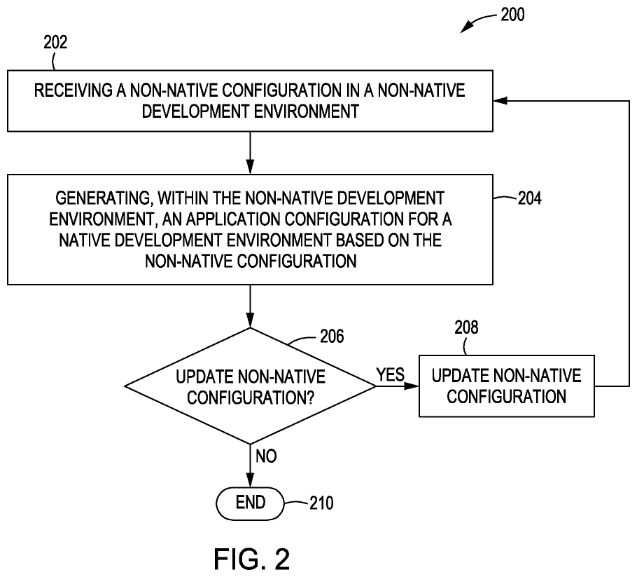

FIG. 2 shows a block diagram of a method 200 for generating an application configuration for a native development environment using the native application configuration generation tool 100. At block 202, the method 200 may include receiving a non-native configuration in a non-native development environment. In some embodiments the non-native configuration may include one or more non-native configuration files, which may include a non-native plugin and/or a non-native library (e.g., third-party library).

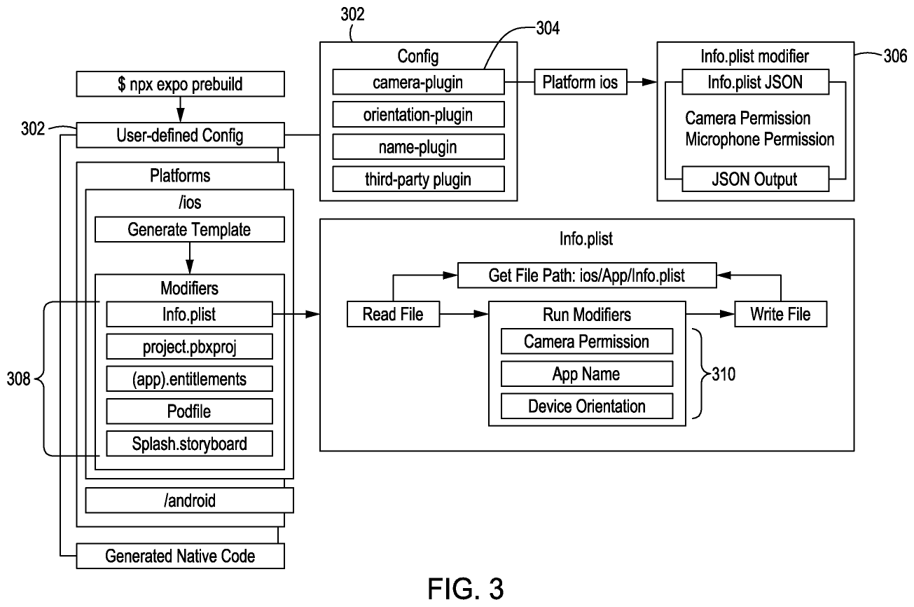

As shown in FIG. 3, in some embodiments, during a prebuild process within the non-native development environment, a user-defined, non-native configuration 302 may be received and may include a directory containing at least one non-native configuration file. A non-native configuration file may be a non-native plugin 304, which can be useful for simplifying reusable actions. For example, as shown in FIG. 3, non-native plugins 304 may be used for certain device functions, such as control of a camera that may be a component used by the native application. Non-native plugins may include third-party plugins as described in greater detail below.

At block 204, the method 200 may include generating, within the non-native development environment, the application configuration for the native development environment based on the non-native configuration. The initial template component 112 may use plugins that define native platforms that generate or otherwise populate the directory 102 of native configuration files 308 as shown in FIG. 3, where each platform corresponds to a native development environment, such as iOS and ANDROID. In some embodiments, each platform may include a base or initial template of the native configuration files 308, which may be modified (e.g., one file at a time) based on the user-defined non-native configuration. The native configuration files 308 together constitute the application configuration for the native development environment.

In some embodiments, and as shown in FIG. 3, the contents of the non-native configuration 302 (configuration files) may be used to modify the native configuration files 308 generated by the initial templates component 112. As shown in FIG. 2, a non-native plugin 304 may contain modifiers specific to a native-development environment that may interact with the template native configuration files 308 in a serialized format. In the example shown in FIG. 2, a non-native camera plugin has modifiers 306 to modify the template INFO.PLIST configuration file.

The config plugin component 116 may be used to modify the INFO.PLIST template file after the initial template component 112 generates the INFO.PLIST template file. As shown in FIG. 3, each modifier 310 may be defined as an object that is associated with the INFO.PLIST configuration file. Each modifier 310 may read the INFO.PLIST file from the initial template or generates one, sequentially evaluates a chain of modifiers in the order they were added, runs the modifiers provided by multiple plugins 304 (e.g., the camera permission modifier provided by the camera plugin, the app name modified provided by the name plugin, the device orientation modifier provided by the orientation plugin) and writes the result to the native configuration file (e.g., INFO.PLIST file). Modifiers may be chained together, and a generic “compiler” evaluates them. Modifiers for other native configuration files 308 shown in FIG. 3 may be used to modify those other native configuration files in the same manner as the modifiers 310 modifying the INFO.PLIST configuration file.

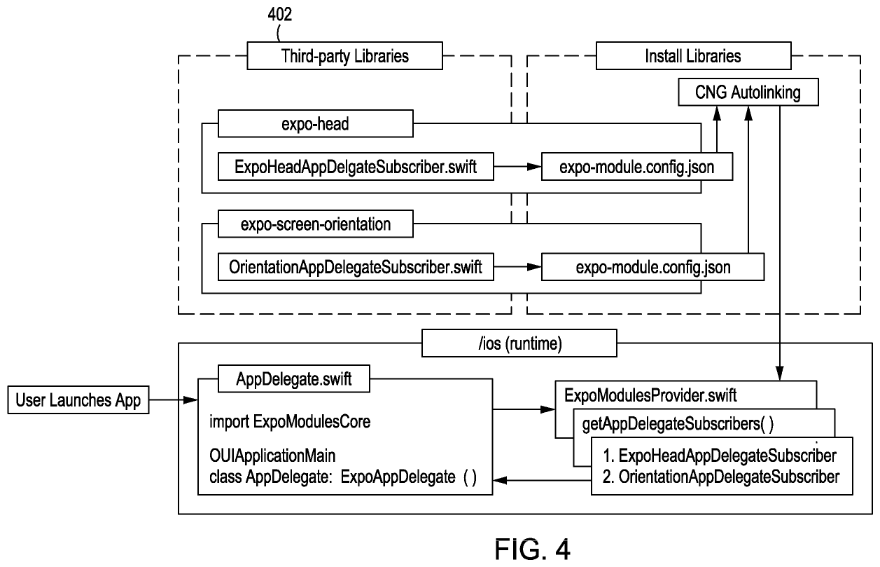

In some embodiments, the lifecycle method component 104 and the autolinking component 108 may be used to generate the AppDelegate.mm and PODFILE, respectively, which may be used to control third-party library subscription and installation. In some embodiments, and as shown in FIG. 4, third-party libraries 402 (node modules) can write modules that subscribe to lifecycle events during runtime of the native application. In some embodiments, the subscribers are registered by having the subscribers define a non-native library configuration file, corresponding to the third-party library, which can be used as an input by the autolinking component 108. For example, in FIG. 4, a module is subscribed to two lifecycle events related to “head” and “orientation” and the subscribers define an “expo-module.config.json” file associated with the third-party libraries 402.

In some embodiments, the autolinking component 108 may be configured to install the third-party libraries 402 to the native configuration files. For example, a library install command may run an autolinking script using the autolinking component 108 to install the third-party libraries. The autolinking component 108 may collect all third-party libraries 402 that have a non-native library configuration file (e.g., “expo-module.config.json) and generate a native library configuration file (e.g., “ExpoModulesProvider.swift”) in the directory 102 with all the third-party libraries.

During native application runtime, various lifecycle events may occur, such as a user launching the application, or foregrounding/backgrounding the application. A main AppDelegate may extend an AppDelegate proxy so that when lifecycle events occur during runtime, the proxy will collect a list of subscribers to update from the “ExpoModulesProvider.swift file. Then, when a lifecycle event occurs, the AppDelegate may trigger a method that is proxied to all subscribers to the lifecycle events.

Once all of the native configuration files 308 are generated and modified and the third-party libraries are subscribed, the resulting directory of native configuration files constitute a native project (i.e., generated native source code) which can be compiled and run or safely discarded. The native configuration files can be readily recreated “on-the-fly” by a user within the non-native development environment from the non-native configuration using the native application configuration generation tool 100. Moreover, a user looking to make a change to the applications across multiple native development environments (i.e., “YES” at block 206) may update the non-native configuration at block 208 to obtain updated native source code without having to manually edit any of the native configuration files.

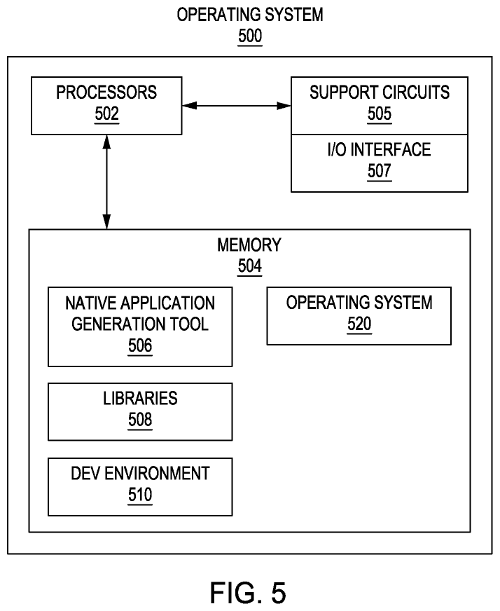

FIG. 5 is a block diagram of a computer system 500 in accordance with exemplary embodiments described herein. The computer system 500 includes processors 502, various support circuits 505, and memory 504. The processors 502 may include one or more microprocessors known in the art. The support circuits 505 for the processor 502 include conventional cache, power supplies, clock circuits, data registers, I/O interface 507, and the like. The I/O interface 507 may be directly coupled to the memory 504 or coupled through the support circuits 505. The I/O interface 507 may also be configured for communication with input devices and/or output devices such as network devices, various storage devices, mouse, keyboard, display, video and audio sensors and the like.

The memory 504, or computer readable medium, stores non-transient processor-executable instructions and/or data that may be executed by and/or used by the processors 502. These processor-executable instructions may comprise firmware, software, and the like, or some combination thereof. Modules having processor-executable instructions that are stored in the memory 504 comprise a native application generation tool 506, various libraries 508 and a development environment 510. The native application generation tool 506 and the development environment may be the same as the native application generation tool and the non-native development environment described herein, respectively.

The computer system 500 may be programmed with one or more operating systems 520, which may include WINDOWS, macOS, LINUX, ANDROID, and iOS, among other known platforms. The memory 504 may include one or more of the following: random access memory, read only memory, magneto-resistive read/write memory, optical read/write memory, cache memory, magnetic read/write memory, and the like, as well as signal-bearing media as described below.

Those skilled in the art will appreciate that computer system 500 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 500 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 500 may be transmitted to computer system 500 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to described embodiments, other and further embodiments may be devised without departing from the basic scope thereof, and the scope thereof is determined by the claims that follow.

1. A method for generating an application configuration for a native development environment, the method comprising:
i. receiving a non-native configuration in a non-native development environment; and
ii. generating, within the non-native development environment, an application configuration for a native development environment based on the non-native configuration.

2. The method of claim 1, wherein the non-native configuration includes one or more non-native configuration files.

3. The method of claim 2, further comprising:
updating at least one of the non-native configuration files; and
repeating ii. after the updating.

4. The method of claim 2, wherein one or more non-native configuration files includes at least one of a non-native plugin or a non-native library.

5. The method of claim 4, wherein the application configuration defines life cycle events, and wherein at least one non-native library is registered with one or more life cycle events, wherein the non-native library is configured to be triggered at run time upon an occurrence of the one or more life cycle events.

6. The method of claim 4, wherein generating includes generating a plurality of template native configuration files and modifying the template native configuration files by running modifier objects associated with at least one non-native plugin.

7. The method of claim 1, wherein generating includes generating a plurality of the application configurations for a plurality of native development environments based on the non-native configuration.

8. One or more non-transitory computer readable media having instructions stored thereon which, when executed by one or more processors, cause the one or more processors to perform operations for generating an application configuration for a native development environment, the operations comprising:
i. receiving a non-native configuration in a non-native development environment; and
ii. generating, within the non-native development environment, an application configuration for a native development environment based on the non-native configuration.

9. The computer readable media of claim 8, wherein the non-native configuration includes one or more non-native configuration files.

10. The computer readable media of claim 9, further comprising:
updating at least one of the non-native configuration files; and
repeating ii. after the updating.

11. The computer readable media of claim 9, wherein one or more non-native configuration files includes at least one of a non-native plugin or a non-native library.

12. The computer readable media of claim 11, wherein the application configuration defines life cycle events, and wherein at least one non-native library is registered with one or more life cycle events, wherein the non-native library is configured to be triggered at run time upon an occurrence of the one or more life cycle events.

13. The computer readable media of claim 11, wherein generating includes generating a plurality of template native configuration files and modifying the template native configuration files by running modifier objects associated with at least one non-native plugin.

14. The computer readable media of claim 8, wherein generating includes generating a plurality of the application configurations for a plurality of native development environments based on the non-native configuration.

15. A system for generating an application configuration for a native development environment, the system comprising:
one or more processors; and
one or more non-transitory computer readable media storing instructions, which, when executed by one or more processors, cause the one or more processors to perform the operations comprising:
i. receiving a non-native configuration in a non-native development environment; and
ii. generating, within the non-native development environment, an application configuration for a native development environment based on the non-native configuration.

16. The system of claim 15, wherein the non-native configuration includes one or more non-native configuration files.

17. The system of claim 16, wherein the operations further comprise:
updating at least one of the non-native configuration files; and
repeating ii. after the updating.

18. The system of claim 16, wherein one or more non-native configuration files includes at least one non-native library, and wherein the application configuration defines life cycle events, and wherein at least one non-native library is registered with one or more life cycle events, wherein the non-native library is configured to be triggered at run time upon an occurrence of the one or more life cycle events.

19. The system of claim 16, wherein one or more non-native configuration files includes at least one non-native plugin, and wherein generating includes generating a plurality of template native configuration files and modifying the template native configuration files by running modifier objects associated with at least one non-native plugin.

20. The system of claim 16, wherein generating includes generating a plurality of the application configurations for a plurality of native development environments based on the non-native configuration.
